(19) United States
(12) Patent Application Publication
(10) Pub. No.: US 2006/0031778 A1
(43) Pub. Date: Feb. 9, 2006

(54) Computing platform for loading resources both synchronously and asynchronously

(75) Inventors: Margaret L. Goodwin, Lynn Wood, WA (US); Mark A. Alcazar, Seattle, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 10/884,745

(22) Filed: Jul. 1, 2004

(51) Int. Cl. G06F 3/00

(52) U.S. Cl. 715/781

(57) ABSTRACT

A platform that provides the ability for a developer to specify different synchronicity properties for navigations within the same application is disclosed. This includes the ability to specify synchronicity globally for the entire application, to specify different synchronicities on different navigation windows within the application, and on different frames within the same navigation window. It also includes the ability to override the synchronicity of a navigation window or frame for a specific hyperlink or navigation without changing the property for other navigations within the same navigation window or frame. Two classes of navigation objects (navigation window and frame) and computer-implemented methods for retrieving and rendering data are disclosed. The navigation objects include a synchronicity attribute that dictates whether the object will render data synchronously (i.e., at one time after the data has been retrieved) or asynchronously (i.e., substantially as the data is received by the client computer and navigation object).

### COPYRIGHT NOTICE

As per 37 CFR §1.71(e), a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This application relates generally to retrieving and rendering data via an application executed on a computer, and more particularly to a computing platform allowing a developer to create user interfaces by loading resources both synchronously and asynchronously.

### BACKGROUND OF THE INVENTION

It is now common for many web applications that present a user interface (UI) to a user to be navigation applications. In general, navigation is the act of retrieving a resource and rendering it as part of creating and displaying a UI for the navigation application to a user. The UI refers to what is displayed or otherwise presented to the user by the application through a display device or other output device. A resource refers an identifiable set of one or more elements of software, such as files or data, that can be retrieved and rendered to form a portion of the UI. An image file, an icon, and a file that when retrieved and rendered creates a clickable button on the UI are examples of simple resources. Individual elements also may be grouped together and provided as single resource, for example a toolbar including buttons, icons, textboxes and the like. In addition to the resources that provide user control described above, the term resource also includes elements of typical web content such as .HTML pages containing text, images, sounds, video, etc.

In order to build complicated UIs, developers of web applications often divide the UI of a web application into separate navigation frames. Furthermore, resources may include nested frames within the resource. Each frame may be directed to navigate to different resources, and thereby create a UI for the web application that is a composite of multiple resources. For example, in a web application UI toolbars, buttons, etc. may be displayed in a top-level, application window, and the content, like a form or document, or a part of the application that performs a subtask that requires specific UI, is in a frame. Yet another frame may be included to display a resource composed of many different elements such as a “home page” containing image files, icons, text, buttons, etc.

The use of navigation frames has become a preferred way to create UIs by web application developers because it provides an easy way to use resources that may be distributed over a network. As long as the resources can be identified, either by location or some other means, and are accessible, one or more navigation frames may be used to easily incorporate the resources into a UI.

Currently, all navigation on the Web is asynchronous. Essentially, asynchronous navigation means that the separate elements (such as icons, buttons, text, images, etc.) that make up a resource navigated to are rendered as they are received. Because navigation is performed by web applications, typically over the Internet or other uncontrolled networks, asynchronous navigation is preferred. Over an uncontrolled network it is possible for the data for resources, or elements within resources, to be delayed in delivery to the rendering computer. Rather than wait until all data is received and possibly create the mistaken impression to a user that the web application is not responding, the preferred practice is to render resources as they arrive.

On the other hand, navigation is currently not used by traditional client-side application developers. Computer application developers are concerned with developing applications for use on a standalone computer platform, such as a personal computer, or within a controlled network environment. Computer application developers assume data for their applications will be easily at hand and quickly available for execution. Computer application developers do not have the same worries as web application developers that there may be delay between a rendering request and actual rendering of a UI, or that some elements of a UI may take substantially longer to obtain than other. Therefore, computer application developers see no benefit, when developing UIs, in navigation in general and in asynchronous navigation in particular. Furthermore, existing client-side development platforms only support synchronous rendering of UI data, so developers do not even have the choice of asynchronous navigation when developing client-side applications.

However, there are times when a mix of application synchronicities, or even a mix of synchronicities within the same application UI, is desirable. For example, an application developer may want a particular navigation frame within a UI window to operate asynchronously, but to have other frames in the UI window to operate synchronously. In another example, a web content provider may want some content (e.g., user interface elements such as buttons or scrollbars provided by the server) within a page to be rendered synchronously, while the rest would be rendered asynchronously.

### SUMMARY OF THE INVENTION

In accordance with the present invention, the above and other problems are solved by providing classes of navigation objects such as navigation windows and frames with a selectable synchronicity. Navigation windows and frames of the present invention include a synchronicity attribute that dictates whether the object will retrieve and render data synchronously (i.e., at one time after all the data has been retrieved) or asynchronously (i.e., elements are rendered at intervals and concurrently as the remaining data is being received). The navigation windows and frames of the present invention thus may be used for either synchronous or asynchronous navigation. The navigation windows and frames retrieve and render resources in accordance with their synchronicity regardless of whether the resource is located on a network or on a local machine tree. Navigation windows and frames allow application developers to specify a default synchronicity for an application, to specify synchronicities for individual navigation objects and to specify the synchronicity of individual navigations. Furthermore, different navigation windows and frames within the same application may have different synchronicities. Such different navigation frames may be concurrently displayed, thereby forming a user interface for the application displaying different resources navigated to with different synchronicities.

In accordance with other aspects, the present invention relates to an application for execution on a computer system that creates a user interface. The application's user interface includes at least one first frame synchronously rendering a first resource into a display area defined by the first frame and thereby displaying the first resource to a user as part of the user interface. The user interface also includes at least one second frame asynchronously rendering a second resource into a display are defined by the second frame and thereby displaying the second resource to the user as part of the user interface. The application uses the same type of frame object to create the first and the second frame—that is the first frame and the second frame are instances of the same object class. In accordance with yet other aspects, the present invention relates to a system executing a computer-implemented method of creating a user interface for an application to a user. The method includes instantiating a first navigation object, in which the first navigation object has a synchronicity attribute. The first navigation object is passed an identifier of a resource to render as part of the user interface for the application. In response, the first navigation object synchronously navigates to the resource if the synchronicity attribute has a first value or asynchronously navigates to the resource if the synchronicity attribute has a second value.

In accordance with yet other aspects, the present invention relates to a system executing a method of retrieving and rendering data with an application. The method includes specifying a desired synchronicity for a navigation frame having a synchronicity attribute. If the desired synchronicity for the navigation is synchronous, setting the synchronicity attribute to a first value that causes the navigation frame to navigate to a resource synchronously or, if the desired synchronicity for the navigation is asynchronous, setting the synchronicity attribute to a second value that causes the navigation frame to navigate to a resource asynchronously. After which, the navigation frame performs navigations resources in accordance with the synchronicity attribute, until the synchronicity attribute is set to a new value or the synchronicity of a specific navigation is explicitly provided.

In accordance with yet other aspects, the present invention relates to a computer-readable medium storing a computer-interpretable data structure for directing a navigation to a resource. The data structure identifies the resource and includes a resource identifier and a synchronicity designator. The resource identifier identifies the name and location of data associated with a resource on a network, wherein the resource if navigated to by a navigation object is rendered to form at least part of a user interface displayed by an application to a user. The synchronicity designator is associated with the resource identifier and causes the navigation object to navigate synchronously if the synchronicity designator is a first value and asynchronously if the synchronicity designator is a second value.

The invention may be implemented as a computer process, a computing system, or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

The aforementioned and various other features as well as advantages, which characterize the present invention, will be apparent from a reading of the following detailed description and a review of the associated drawings.

### BRIEF DESCRIPTION OF THE DRAWINGS

FIG. 1 shows a computer network implementing an embodiment of the present invention.

FIG. 2 is a block diagram illustrating the operations of navigation performed by a navigation object in accordance with an embodiment of the present invention.

FIG. 3 illustrates the architecture of a computer system suitable for implementing an embodiment of the present invention.

FIG. 4 illustrates an operational flow diagram of a system for creating a user interface by using a navigation object to synchronously or asynchronously navigate to a resource to be used as part of the user interface according to one embodiment of the present invention.

FIG. 5 illustrates an exemplary navigation object class having a synchronicity attribute according to one embodiment of the present invention.

### DETAILED DESCRIPTION OF THE INVENTION

Embodiments of the present invention include a platform and components for creating application user interfaces from separate resources in which some resources are navigated to synchronously and some resources are navigated asynchronously. Under this platform, the application developer has the ability to specify whether an application should perform all navigations synchronously or asynchronously. Furthermore, the application developer may specify the navigation synchronicity (i.e., either synchronous or asynchronous) of specific windows within the application, or individual frames within a window, or of specific acts of navigation such as to specific resources or under specific conditions.

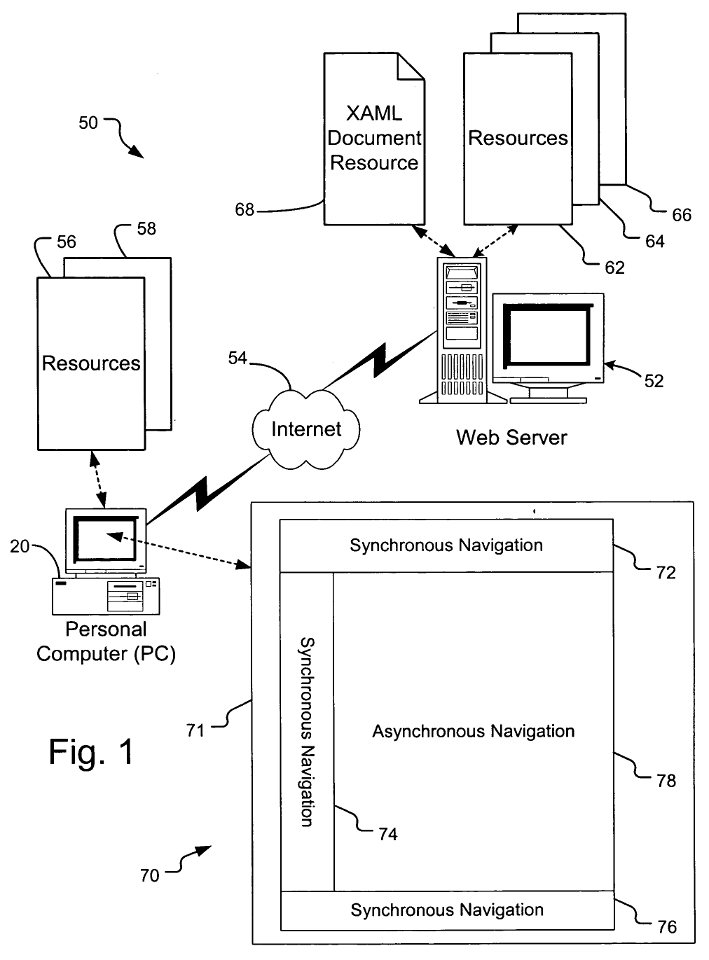

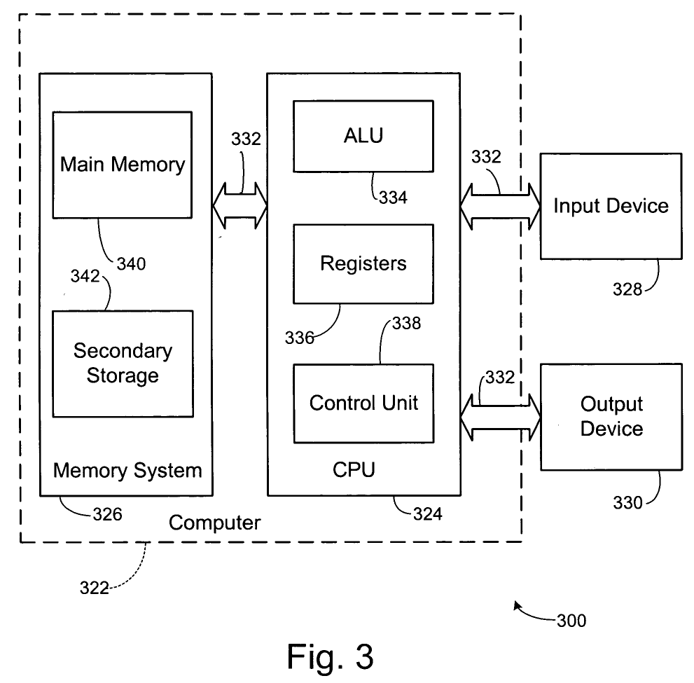

Referring to FIG. 1, an exemplary environment 50 implementing one particular embodiment of the present invention is depicted. FIG. 1 illustrates a computer network of connected computing devices in which a web server 52 is connected to a client computer 20 via a network 54, such as the Internet, as shown. The web server 52 and client computer 20 may be a general purpose computing device, as described with reference to FIG. 3, or a purpose-built computing device. They may be connected to the network via wired or wireless connections as art known in the art, possibly requiring modems or other connectivity devices.

In the embodiment shown, the web server 52 and the client computer host exemplary resources 56, 58, 62, 64, 66, 68. The exemplary resources include electronic data that define user interface (UI) elements and may be navigated to by the client computer 20. Usually, each resource is a file that contains one or more UI elements laid out in a particular fashion to create the UI that gets displayed. The resource is located at a particular location on a server or local machine, and located using an identifier such as a uniform resource identifier. However, while resources may be discrete files, they also may be generated in response to a navigation. The electronic data may be in any format interpretable by the client computer, such as HTML, XAML, JPEG, .pdf. For example, the resources may include metadata that describes how other data in the resource should be interpreted by the rendering computer. The use of metadata in this context is well known and need not be described herein. For the purposes of this specification, resources shall be referred to generally as including data and the reader should understand that the data may take many forms.

In the exemplary embodiment shown, one resource 68 is an XAML document that may contain or link to a plurality of content elements such as images, text, graphics, etc. FIG. 1 also shows three resources 62, 64, 66 stored on the web server 52 that are user control resources, for example toolbars and title bars, for use by one or more navigation applications to provide user controls to a UI displayed by a navigation application. By navigation application, it is meant an application that uses at least one navigation window or frame that uses navigation to retrieve and render a resource in order to display a UI to the user. It should be understood that resources may be stored locally as part of a machine tree or remotely, such as on a web server. To illustrate this, client computer 20 is also shown to have stored thereon several resources 56, 58, which in this embodiment are control resources.

Resources on a network may be identified by a uniform resource identifier (URI), a uniform resource locator (URL) or by some other identification means. URLs, URIs and other means of identifying data stored on a network are known in the art. Typically, in order to navigate to a resource, the identifier of that resource must be known, and the resource must be available to the computer system and navigation application performing the navigation.

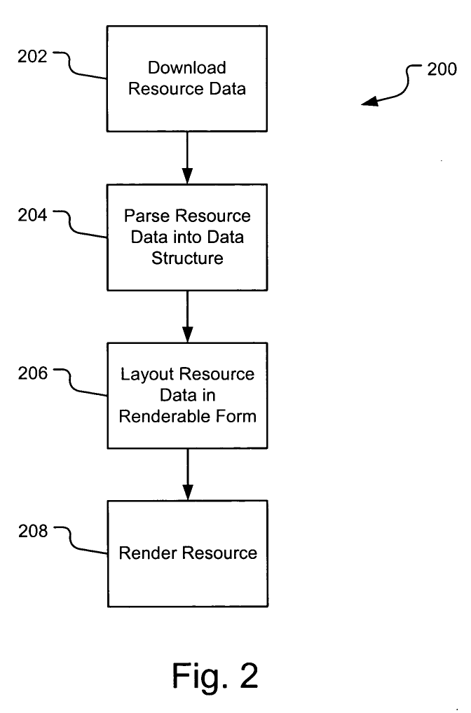

The client computer 20 executes a navigation application that may navigate to the resources 62, 64, 66, 68 of the web server 52 via the connection to the network 54. In addition, the navigation application may navigate to the locally stored resources 56, 58 or any other resources (not shown) that it can identify and has access to, regardless of the actual location of the resource. Navigation may involve retrieving some or all of the resource and rendering it on the client computer's display. Alternatively, navigation may include the initial downloading and execution of code to generate a resource in memory, which is then navigated to in the same manner as a pre-existing resource. Such execution may occur at the client computer or the server depending on the implementation. Navigation or “navigating to a resource,” in a very general sense, can be considered to include the acts necessary to retrieve and render a resource in order to form some portion of a UI. Navigation is discussed in greater detail with reference to FIG. 2, below.

The navigation application presents to the user a UI 70, in part, by rendering resources onto the client computer's display. The UI 70 includes an application window 71. Typically, the application window 71 defines the area of the UI and provides an external boundary within which the UI is rendered. In object-oriented programming, application window 71 is implemented as a distinct instantiation of a class of application window objects.

Within the navigation window 71 are shown three panels of UI elements 72, 74, 76, and a frame 78. The navigation window 71 navigates to a resource 56 that contains the top-level UI of the application including elements 72, 74, 76, as well as a frame 78, which navigates to a separate resource 68 in order to display that resource as part of the UI 70. Together, the application window 71 and the navigation frame 78 create the application UI 70 for the navigation application that is displayed to the user.

The navigation window 71 navigates to a resource and displays that resource to the user within the display area of the window. That resource contains a frame 78 that navigates to another resource in a separate file.

In embodiments of the present invention, there may be multiple navigation windows 71 and frames 78 in the same application and, although the windows and frames may be instantiations of the same class of object, they may navigate to their respective resources synchronously or asynchronously, as determined by a synchronicity property set on each instance by the developer of the application. For example, in the embodiment shown there is a toolbar 72 along a top portion of the UI 70, another control 74 is positioned along a left portion of the UI 70, and, a third control 74 positioned along a bottom portion of the UI 70. All of these controls, along with the layout declarations that determine their respective positions in the window, are contained in a singe resource file.

In the embodiment shown, the navigation window 71 navigating to the resource that contains the top-level UI elements 72, 74, 76 of the application performs synchronous navigation. That is, the resource data is retrieved and rendered synchronously, even though the resource is obtained through navigation and may possibly reside in a remote location, such as on the web server 52. The application developer chose to use synchronous navigation in order to ensure that the application's top-level UI controls are displayed synchronously to the user.

In the discussion above, the navigation window 71 is specified as synchronous, which means the resource containing the UI elements docked at the top, left, and bottom of the page 72, 74, 76 are downloaded, parsed, and rendered synchronously.

The navigation frame 78, on the other hand, uses asynchronous navigation to retrieve and render resources into its display area. In the embodiment, this frame 78 is the main content display frame and is used to navigate to resources that contain large amounts of content, such as the XAML document 68, possibly having multiple individually renderable elements. For this frame 78, asynchronous navigation is appropriate as the resource navigated to may be very large, may change in size and content over time, or may contain numerous content elements for which synchronous display to the user is unimportant.

Using windows 71 and frames 78 of different synchronicities allows application developers to tailor how the navigation application UI 70 is presented to the user. By using synchronous navigation for a window 71 navigating to a resource having a toolbar, the developer ensures that the user will not be presented with unintelligible portions of the toolbar based on when the various elements of the toolbar resource are received. However, the application developer is also able to designate asynchronous navigation for frames navigating to resources, such as resources containing content like text, images, etc., where asynchronous navigation is the most appropriate. For example, a large document may take a long time to download, and as the user can only see one screenful at a time, it is preferred to display the document as it arrives. The user can scroll through the beginning of the document while the rest of it is still arriving.

FIG. 2 illustrates some of the operations that occur during an embodiment of navigation in accordance with the present invention. The operations are performed by each navigation window and frame of a navigation application. Note that each navigation window and frame is capable of doing synchronous or asynchronous navigation in accordance with its synchronicity attribute.

Navigation begins, usually in response to a user command or a computer generated command to retrieve a resource with a given identifier, with a download operation 202 in which the electronic data that defines the resource to be navigated to is received by the navigation application. The received data may be temporarily buffered or otherwise stored until the data is acted on by the parsing operation 204. The download operation 202 downloads a stream of bits and passes them to the parser for parsing in parsing operation 204. The download operation 202 also may be considered to include whatever actions are necessary to cause the resource to be transmitted to the computing system. In some cases this may include sending a request using the given identifier to a remote system. Alternative methods of obtaining local and remote data are well known in the art and may be used.

Parsing operation 204 parses the received data into a data structure. In the case of asynchronous navigation, each element is parsed into a separate data structure. In the case of synchronous navigation, the entire resource is parsed into a single data structure. The data structure may be stored in a temporary or permanent location on the computer executing the navigation application.

The parser parses the stream and tokenizes it into individual elements. If the navigation is asynchronous, each element is passed to the layout engine as it is parsed and, if an element requires a secondary download (e.g., an image file that has to be retrieved from another location), the parser continues parsing other data while waiting for the rest of that stream to arrive. If the navigation is synchronous, the parser will block on a secondary download, and not parse anything else until that stream is fully downloaded and processed.

By elements, it is meant independently renderable elements of the resource. The elements may be, for example, distinct images, text, buttons, graphics, etc., within a resource, such as a HTML document or a XAML file resources. In particular, each element can be parsed and rendered separately from the other elements. In addition, depending on the embodiment some resources may be rendered in increments, such as in horizontal portions of an image. In that case, each distinctively renderable portion may be considered its own separate element.

After parsing, the parser passes the data structure or structures to the layout engine for layout operation 206. Layout operation 206 determines how to arrange them in the window or frame, based on their size and positioning properties. If the operation is asynchronous, the layout engine may be called iteratively to rearrange elements when new elements are added to the layout. If the operation is synchronous, the layout engine can lay out the entire page at once, because it has all the information in advance.

The laid out data is then rendered by render operation 208. Render operation 208 renders the data of the resource into the display area of the navigation window or frame that is performing the navigation. The rendering is done in accordance with the instructions, if any provided with the resource data, as determined in the layout operation 206. For asynchronous navigation, each element is rendered separately or in batches, sometime after the layout operation 206 completes the layout of that element. For synchronous navigation, the entire resource is rendered by the navigation window or frame in a single rendering operation.

In an alternative embodiment, synchronous navigation is performed using asynchronous downloading, asynchronous parsing and asynchronous layout. Only the render operation 208 is performed synchronously.

Exemplary Operating Environment

FIG. 3 and the following discussion under this subheading are intended to provide a brief, general description of a suitable computing environment in which one embodiment of the invention may be implemented. Although not required, the invention may be described in the general context of computer executable instructions such as program modules being executed by a personal computer (PC). Generally, program modules include routines, programs, objects, components, data structures, etc., that perform particular tasks or implement particular abstract data types. Moreover, those skilled in the art will appreciate that the invention may be practiced with other computer system configurations, including hand-held devices, multiprocessor systems, micro-processor based or programmable consumer electronics, network PCs, mini computers, telephones, PDAs, game devices, main frame computers and the like. The invention may also be practiced in distributed computing environments where tasks are performed by remote processing devices that are linked through a communications network in a distributed computing environment, program modules may be located in both local and remote memory storage devices.

An exemplary system for implementing the invention is shown in FIG. 3. The system comprises a computer system 300 incorporating a computer 322 in the form of a PC that comprises at least one central processing unit (CPU) 324, a memory system 326, an input device 328, and an output device 330. These elements are coupled by at least one system bus 332.

The CPU 324 is of familiar design and includes an Arithmetic Logic Unit (ALU) 334 for performing computations, a collection of registers 336 for temporary storage of data and instructions, and a control unit 338 for controlling operation of the system 300. The CPU 324 may be a microprocessor having any of a variety of architectures including, but not limited to those architectures currently produced by Intel, Cyrix, AMD, IBM, DEC and Motorola.

The system memory 326 comprises a main memory 340, in the form of media such as random access memory (RAM) and read only memory (ROM), and a secondary storage 342 in the form of long term storage mediums such as hard disks, floppy disks, tape, compact disks (CDs), flash memory, etc., and other devices that store data using electrical, magnetic, optical or other recording media. The main memory 340 may also comprise video display memory for displaying images through the output device 330, such as a display device. The memory 326 can comprise a variety of alternative components having a variety of storage capacities such as magnetic cassettes, memory cards, optical discs, random access memories, read only memories, and the like may also be used in the exemplary operating environment. Memory devices within the memory system 326 and their associated computer readable media provide storage of computer readable instructions, data structures, program modules and other data for the computer system 322.

The system bus 332 may be any of several types of bus structures including a memory bus or memory controller, a peripheral bus, and a local bus using any of a variety of bus architectures.

The input and output devices 328 and 330 are also familiar. The input device 328 can comprise a keyboard, a mouse, a microphone, etc. The output devices 330 can comprise a display, a printer, a speaker, etc. Some devices, such as a network interface or a modem can be used as input and/or output devices. The input and output devices 328 and 330 are connected to the computer 322 through system buses 332.

The computer system 300 further comprises an operating system (not shown). The operating system comprises a set of software commands that controls the operation of the computer system and the allocation of resources. Preferably, the operating system employs a graphical user interface where the display output of an application program is presented on the display device 330. Exemplary operating systems include the Microsoft Windows 98, Microsoft Windows 2000, and Microsoft Windows XP operating systems. Additionally, the operating system may include networking software having capabilities of interacting with other computers over a computer network.

Additionally, the computer system 300 may comprise one or more application programs wherein each application program is a set of software instructions that performs specific functions using computer resources made available through the operating system. Such applications may include word processors such as Word, WordPerfect, etc., for creating and editing documents, browsers such as Internet Explorer, Netscape Navigator, Mozilla, etc., for navigating content, file managers for accessing and managing files, and so on. These applications are resident in the memory system 326.

The computer system 300 includes at least one navigation application in accordance with the present invention. The navigation application, when executed, displays a UI to the user that simultaneously includes at least one synchronous navigation window or frame and at least one asynchronous navigation window or frame. The synchronous navigation window or frame synchronously navigates to a resource that is then rendered in the display area of the window or frame as part of the UI of the navigation application. The asynchronous navigation window or frame asynchronously navigates to a resource resulting in the asynchronous rendering of the resource in the display area of the asynchronous window or frame as part of the UI of the navigation application.

Navigation Application Embodiments

Embodiments of the present invention include navigation windows and frames for which the synchronicity of the navigation window or frame is set when an instance of the window or frame class is instantiated. Although each instance of a window or frame has a synchronicity that must be set upon instantiation, the decision as to what synchronicity to set a particular instance to is made by a developer at the time the application is written. The ability to select the synchronicity allows a developer to write an application that alternately includes navigation windows and frames of different synchronicities, while using the same navigation window and frame classes.

In one embodiment of the present invention, classes of navigation objects are implemented with an API referred to as the INavigator interface. The INavigator interface allows the application developer to leverage all the properties, methods, and events required for navigation, including varying the navigation synchronicity as the developer desires. In one embodiment, the navigation window and frame directly implement or inherit the INavigator interface, which provides a consistent navigation API across both classes. This API allows different synchronicities to be used by an application as necessary. It further allows an application to create multiple instances of navigation frames, each having a different synchronicity within the same window. An exemplary specification of an embodiment of an INavigator interface is provided at the end of this specification.

In one embodiment of the present invention, one class implements the INavigator interface. All navigation takes place inside an instance of that class, or a class derived from it. In this case, the navigation code only needs to be implemented in one place. In another embodiment, the navigation window and frame classes each may implement the INavigator interface directly.

In some embodiments the navigation object classes are provided by the operating system as a resource to applications executing within the operating system's environment. The same navigation window and frame classes may be used by different applications with different needs. In an alternative embodiment, the classes may be provided with the application or they may be obtained by the application from a remote computing system when needed.

In one embodiment of the present invention, there is a proxy class that provides a layer of abstraction that allows the developer to treat a browser as a NavigationWindow. This makes it easy to write applications that can be converted from browser-based (i.e., applications that require a browser to be executed) to standalone, simply by changing a single attribute or setting. U.S. patent application Ser. No. 10/376,360, titled SYSTEM AND METHOD OF HOSTING AN APPLICATION IN ONE OF A PLURALITY OF EXECUTION ENVIRONMENTS, discusses this in greater detail and is incorporated herein by reference.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

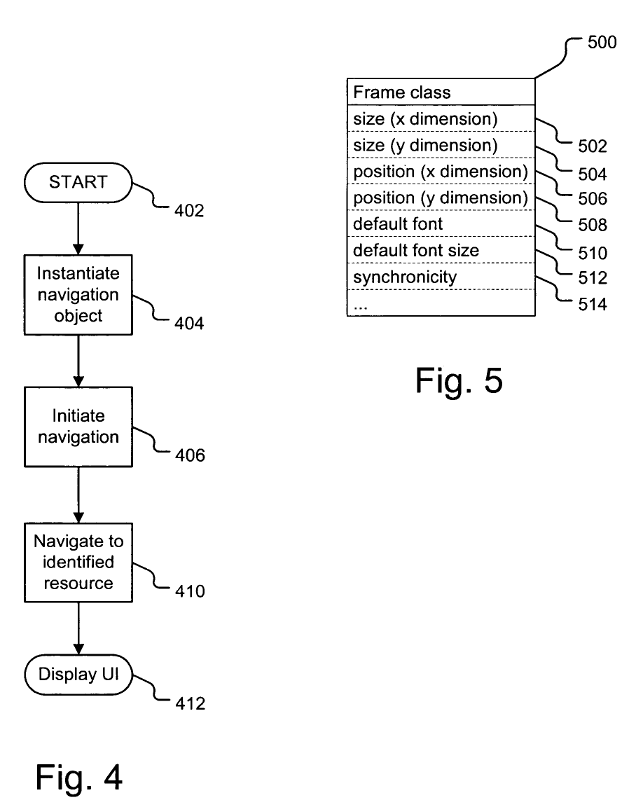

Referring to FIG. 4, a method is illustrated for creating an application UI that includes resources according to one embodiment of the present invention. This method may be implemented as a software program written in any appropriate programming language, such as the C# or C++ programming language.

The method starts in an initiation operation 402 when it is determined that a navigation needs to be performed or a navigation object must be instantiated. For example, this may be due to a user command to execute some application, which subsequently instantiates one or more navigation window or frame, or a user clicking on a hyperlink to display the identified resource. Alternatively, the determination may be made by the operating system in response to some occurrence, such as receipt of an email.

Once it has been determined that a navigation object is necessary, the appropriate class is retrieved from the class library, and a navigation window or frame of said class is instantiated in an instatiation operation 404. The class may be provided by the operating system, may be unique to the application, or may be retrieved from a known location on a network depending on the implementation of the application. The navigation class of objects includes a navigation API and a synchronicity attribute. Embodiments of the class include the NavigationWindow, NavigationContainer and Frame classes described herein.

During instantiation, the synchronicity of the navigation object is set by setting the synchronicity attribute to a value. In the embodiment, a default synchronicity may be specified for an application, and that synchronicity will be set by default on any navigation window or frame instantiated by the application that doesn't have its own synchronicity explicitly specified. Alternatively, the instantiation operation 404 may include explicitly setting the synchronicity attribute of the navigation object to a specific value. In this case the synchronicity specified on a particular navigation window or frame will always override the application's default synchronicity.

After instantiation of the navigation object, every navigation taking place inside a navigation window or frame abides by the synchronicity setting of that window or frame, unless it is overridden by a different synchronicity specified either on a hyperlink or a navigation method. For example, if a hyperlink has its synchronicity attribute set to True, whenever a user clicks that hyperlink, the navigation will be synchronous, regardless of the synchronicity of the containing frame or navigation window. Likewise, if a navigation is initiated by invoking the Navigate method, and the call invoking method has a synchronicity specified in its arguments, the synchronicity specified by the call will override any synchronicity setting on the current frame or navigation window.

After instantiation operation 404, the navigation object can perform navigations. Each navigation begins with an initiation operation 406. In the initiation operation 406, the instantiated navigation object receives a command to perform a navigation to an identified resource. The initiation operation 406 may occur in response to a user clicking on a hyperlink or may be in response to the opening of a new application. In any case, during the initiation operation 406 a resource identifier such as a URL or URI as described above, is passed or otherwise provided to the navigation window or frame. As mentioned above, the resource identifier may be passed in such a way as to change the synchronicity of the navigation window or frame for the duration of the navigation to the identified resource.

After identification of the resource and receipt of a command to navigate to the resource, a navigation operation 410 is performed. In the navigation operation 410, if the synchronicity was not overridden as described above the current value of the synchronicity attribute is read and the navigation is performed with the synchronicity dictated by the synchronicity attribute. A detailed embodiment of a navigation operation was described above with reference to FIG. 2. Generally, the navigation operation 410 includes retrieving the resource's data from the identified location, parsing it, and rendering it to create a new UI that now incorporates the resource. Upon rendering the user is presented with a UI that contains the resource within the navigation window or frame. It should be noted that, for asynchronous navigation, multiple renderings may be performed as the various elements of the resource arrive, are parsed and laid out. In that case, the UI may be created over time as the UI is redrawn as each element is received.

After the navigation is complete, the result is that the UI now incorporating the resource is presented to the user on the display device. If the resource contains an interactive control, such as a clickable button or hyperlink, the user is now able to perform the interaction. As described above, a UI created in accordance with the present invention may include any number of navigation frames and windows with any mix of synchronicities. Thus, it is possible that different navigation windows and frame of different synchronicities may be simultaneously navigating to different resources in response to a user command.

FIG. 5 illustrates one embodiment of attributes of a navigation object class 500 that exposes this INavigator API in accordance with the present invention. Class 500 includes several attributes, including a synchronicity attribute 514. Exemplary attributes include frame size values in the x and y dimension (502 and 504, respectively) which define the initial size of the frame in both of its two dimensions, x and y position values (506 and 508, respectively) which determine where the frame is initially rendered, a default font setting 510 to be used in the frame along with a default font size 512, and a synchronicity attribute 514 as discussed previously. In one embodiment, the synchronicity attribute is a Boolean attribute that retrieves and renders data synchronously if the attribute is “True” and asynchronously if the attribute is “False.” Alternative attribute schemes for selecting between two states are known in the art and may be alternatively used here.

Further, the classes may contain any combination of the illustrated attributes, and additional attributes not illustrated, such as attributes associated with other APIs exposed by the class 500. Additional detail concerning attributes of an exemplary embodiment of the INavigator interface are provided in the following section.

Exemplary Embodiment of a Specification of an INavigator Interface

The material in this section is copyrighted 2003 by Microsoft Corporation.

In an exemplary embodiment, navigation windows and frames, via the INavigator interface, perform the following functions:
Initiate a navigation synchronously or asynchronously.
Navigate back or forward, refresh the current page, and stop a navigation in progress.
Handle navigation events and navigation errors.
Determine whether to enable/disable the UI for Back, Forward, Stop, Refresh.
Access Uri of the current page.
Access root element of the current page.
Access the Journal to add or remove journal entries.
Navigation to an anchor within a page.
Navigation may target a specific frame or window.
Specify whether navigation is synchronous or asynchronous by default for the application, per frame, or per navigation.
Event for opening a new window on a navigation.
Navigate by setting a property.
Navigating to the same app in address bar doesn't relaunch app.
Declaratively targeting new window on hyperlink.

A exemplary class definition in C++ is as follows:

```
public class INavigator
{
    public Uri Uri {get; set;}
    public Uri CurrentUri {get;}
    public bool Synchronous {get;set;}
    public UIElement Content {get;set;}
    public Journal Journal {get;}
    public bool CanGoForward {get;}
    public bool CanGoBack {get;}
    public bool Navigate(Uri uri);
    public bool Navigate(Element content);
    public bool Navigate(Uri uri, bool synchronous);
    public bool Navigate(Uri uri, bool synchronous,
                        Object navigationState);
    public void GoForward( );
    public void GoBack( );
    public void StopLoading( );
    public void RefreshContent( );
    event NavigatingCancelEventHandler Navigating;
    event LoadStartedEventHandler LoadStarted;
    event NavigationProgressEventHandler NavigationProgress;
    event NavigationErrorCancelEventHandler NavigationError;
    event NavigatedEventHandler Navigated;
    event LoadCompletedEventHandler LoadCompleted;
    event StoppedLoadingEventHandler StoppedLoading;
    event NavigatingNewWindowCancelEventHandler
                        NavigatingNewWindow;
    event LoadingImageCancelEventHandler LoadingImage;
    event ImageLoadingErrorEventHandler ImageLoadingError;
    event ImageLoadedCancelEventHandler ImageLoaded;
}
```

Attributes of an exemplary embodiment of the INavigator class are described in Table 1.

TABLE 1

| Attribute | Description |
|---|---|
| public Uri Uri {get; set;} | Uri for the page currently contained by the |
| | NavigationContainer. Setting this property |
| | performs a navigation to the specified Uri. |
| | Whether the navigation is synchronous or |
| | asynchronous depends on the current default. |
| | Getting this property when a navigation is not |
| | in progress returns the URI of the current page. |
| | Getting this property when a navigation is in |
| | progress returns the URI of the page being |
| | navigated to. |
| | Note: Supporting navigation via setting a |
| | property makes it possible to write a |
| | NavigationWindow in markup and specify its |
| | initial content. |
| public Uri CurrentUri | Uri for the current page in the |
| {get;} | NavigationContainer. Getting this property |
| | always returns the URI of the content that's |
| | currently displayed in the NavigationContainer, |
| | regardless of whether a navigation is in |
| | progress or not. |
| public bool Synchronous | Specifies whether navigations within this |
| {get;set;} | INavigator instance are by default synchronous |
| | or asynchronous. This can be overridden by the |
| | Navigate method, using the parameter. The |
| | default value of the Synchronous property on |
| | an INavigator is the same as the value specified |
| | for the Synchronous property on the |
| | NavigationApplication. |
| | (If the Application is not a |
| | NavigationApplication, the Synchronous |
| | property defaults to False.) |
| public UIElement | Root element of the content in the |
| Content {get;set;} | NavigationContainer. Setting this property |
| | performs a navigation to the specified element. |
| | Getting this property returns the root element |
| | of the element tree currently contained in the |
| | NavigationContainer. |
| public Journal Journal | Journal for the NavigationContainer. Maintains |
| {get;} | Back/Forward navigation history. |
| public bool | Tells whether there are any entries in the |
| CanGoForward {get;} | Forward branch of the Journal. This property |
| | can be used to enable the Forward button. |
| public bool CanGoBack | Tells whether there are any entries in the Back |
| {get;} | branch of the Journal. This property can be |
| | used to enable the Back button. |

Methods of an exemplary embodiment of the INavigator class are described in Table 2.

TABLE 2

| Method | Description | Parameter | Return Value |
|---|---|---|---|
| public bool Navigate | Navigates to the Uri | uri - URI of the | False if the |
| (Uri uri) | and downloads the | application or content | navigation was |
| | content. Whether the | being navigated to. | cancelled. |
| | navigation is | | Otherwise, true. |
| | performed | | |
| | synchronously or | | |
| | asynchronously | | |
| | depends on the | | |
| | current default | | |
| | navigation behavior. | | |
| public bool Navigate | Navigates | content - Root of the | False if the |
| (Element content) | synchronously to an | element tree being | navigation was |
| | existing element tree. | navigated to. | cancelled. |
| | | | Otherwise, true. |
| public bool Navigate | This overloaded | Uri - URI of the | False if the |
| (Uri uri, bool | method is used when | application or page being | navigation was |
| synchronous) | the developer wants a | navigated to. | cancelled. |
| | specific navigation to | synchronous - Specifies | Otherwise, true. |
| | have a different | whether the navigation | |
| | default navigation | should be synchronous. | |
| | behavior than the | When the value of this | |
| | default navigation | parameter is “true”, the | |
| | behavior currently in | NavigationContainer | |
| | effect for the | navigates synchronously | |
| | NavigaionContainer | to an existing element | |
| | in which the | tree. The user stays on | |
| | navigation is taking | the page from which the | |
| | place. | navigation was initiated | |
| | | until the entire | |
| | | navigation and download | |
| | | is complete. When the | |
| | | method returns, the new | |
| | | page is swapped in all at | |
| | | once. (No incremental | |
| | | loading). When the value | |
| | | is “false” the navigation | |
| | | is asynchronous. | |
| public bool Navigate | This overloaded | Uri - URI of the | False if the |
| (Uri uri, bool | method is used when | application or page being | navigation was |
| synchronous, Object | the developer wants a | navigated to. | cancelled. |
| NavigationState) | specific navigation to | synchronous - Specifies | Otherwise, true. |
| | have a different | whether the navigation | |
| | default navigation | should be synchronous. | |
| | behavior than the | When the value of this | |
| | default navigation | parameter is “true”, the | |
| | behavior currently in | NavigationContainer | |
| | effect for the | navigates synchronously | |
| | NavigaionContainer | to an existing element | |
| | in which the | tree. The user stays on | |
| | navigation is taking | the page from which the | |
| | place. | navigation was initiated | |
| | | until the entire | |
| | | navigation and download | |
| | | is complete. When the | |
| | | method returns, the new | |
| | | page is swapped in all at | |
| | | once. (No incremental | |
| | | loading). When the value | |
| | | is “false” the navigation | |
| | | is asynchronous. | |
| | | navigationData - Extra | |
| | | data specified by the | |
| | | developer to pass along | |
| | | with the navigation. This | |
| | | object will be accessible | |
| | | from the Navigating, | |
| | | LoadStarted, Navigated, | |
| | | LoadCompleted, and | |
| | | NavigationError events. | |
| | | This may be used as an | |
| | | identifier for | |
| | | asynchronous | |
| | | navigations, so the | |
| | | developer can determine | |
| | | which navigation an | |
| | | event applies to. | |
| public void GoForward | Navigates to the next | | |
| ( ) | entry in the Forward | | |
| | branch of the Journal, | | |
| | if one exists. If there | | |
| | is no entry in the | | |
| | Forward stack of the | | |
| | journal, the method | | |
| | throws an exception. | | |
| | The behavior is the | | |
| | same as clicking the | | |
| | Forward button. | | |
| public void bool | Navigates to the | | |
| GoBack ( ) | previous entry in the | | |
| | Back branch of the | | |
| | Journal, if one | | |
| | exists. If there is no | | |
| | entry in the Forward | | |
| | stack of the journal, | | |
| | the method throws an | | |
| | exception. The | | |
| | behavior is the same | | |
| | as clicking the Back | | |
| | button. | | |
| public | Stops the navigation | | |
| bool StopLoading ( ) | or download | | |
| | currently in | | |
| | progress. If there is | | |
| | no navigation or | | |
| | download currently | | |
| | in progress, the | | |
| | method throws an | | |
| | exception. The | | |
| | behavior is the same | | |
| | as clicking the Stop | | |
| | button. | | |
| public void Refresh ( ) | Reloads the current | | |
| | content. The | | |
| | behavior is the same | | |
| | as clicking the | | |
| | Refresh button. | | |

Events of an exemplary embodiment of the INavigator class are described in Table 3.

TABLE 3

| Event | Description |
|---|---|
| event NavigatingCancelEventHandler | Raised just before a navigation takes place. |
| Navigating | This event is fired for frame navigations as |
| | well as top-level page navigations, so may fire |
| | multiple times during the download of a page. |
| | The NavigatingCancelEventArgs contain the |
| | uri or root element of the content being |
| | navigated to and an enum value that indicates |
| | the type of navigation. |
| | Canceling this event prevents the application |
| | from navigating. |
| | Note: An application hosted in the browser |
| | cannot prevent navigation away from the |
| | application by canceling this event. |
| | Note: In the PDC build, if an application hosts |
| | the WebOC, this event is not raised for |
| | navigations within the WebOC. |
| event LoadStartedEventHandler LoadStarted | Raised just after a top-level navigation begins. |
| | This is the event to handle to begin spinning |
| | the globe. The developer should check the |
| | NavigationInitiator property on the |
| | NavigationEventArgs to determine whether to |
| | spin the globe. |
| | The NavigationEventArgs contain the uri or |
| | root element of the content being navigated to, |
| | and a NavigationInitiator property that |
| | indicates whether this is a new navigation |
| | initiated by this INavigator, or whether this |
| | navigation is being propagated down from a |
| | higher level navigation taking place in a |
| | containing window or frame. |
| | This event is informational only, and cannot be |
| | canceled. |
| event NavigationProgressEventHandler | Raised at periodic intervals while a navigation |
| NavigationProgress | is taking place. |
| | The NavigationProgressEventArgs tell how |
| | many total bytes need to be downloaded and |
| | how many have been sent at the moment the |
| | event is fired. This event can be used to |
| | provide a progress indicator to the user. |
| | This event is informational only, and cannot be |
| | canceled. |
| event NavigationErrorCancelEventHandler | Raised when a navigation or download error |
| NavigationError | has occurred. This error event should be raised |
| | for errors navigating to an anchor within a |
| | page, as well as to a top level page. |
| | The NavigationErrorCancelEventArgs also |
| | contain the error status code and the exception |
| | that was thrown. |
| | Canceling this event prevents the default error |
| | message from being displayed to the user. A |
| | handler for this event might redirect to a |
| | custom error page or put up a custom error |
| | message. |
| event NavigatedEventHandler Navigated | Raised after navigation the target has been |
| | found and the download has begun. This event |
| | is fired for frame navigations as well as top- |
| | level page navigations, so may fire multiple |
| | times during the download of a page. |
| | For an asynchronous navigation, this event |
| | indicates that a partial element tree has been |
| | handed to the parser, but more bits are still |
| | coming. |
| | For a synchronous navigation, this event |
| | indicates the entire tree has been handed to the |
| | parser. |
| | The NavigationEventArgs contain the uri or |
| | root element of the content being navigated to. |
| | This event is informational only, and cannot be |
| | canceled. |
| event LoadCompletedEventHandler | Raised after the entire page, including all |
| LoadCompleted | images and frames, has been downloaded and |
| | parsed. This is the event to handle to stop |
| | spinning the globe. The developer should |
| | check the NavigationInitiator property on the |
| | NavigationEventArgs to determine whether to |
| | stop spinning the globe. |
| | The NavigationEventArgs contain the uri or |
| | root element of the content being navigated to, |
| | and a NavigationInitiator property that |
| | indicates whether this is a new navigation |
| | initiated by this INavigator, or whether this |
| | navigation is being propagated down from a |
| | higher level navigation taking place in a |
| | containing window or frame. |
| | This event is informational only, and cannot be |
| | canceled. |
| event NavigationStoppedEventHandler | Raised when a navigation or download has |
| NavigationStopped | been interrupted because the user clicked the |
| | Stop button, or the Stop method was invoked. |
| | The NavigationEventArgs contain the uri or |
| | root element of the content being navigated to. |
| | This event is informational only, and cannot be |
| | canceled. |
| event | Raised when the target of the navigation is a |
| NavigatingNewWindowCancelEventHandler | new window. The navigation does not take |
| NavigatingNewWindow | place in the NavigationContainer that fires this |
| | event (the content in the current |
| | NavigationContainer doesn't change), and no |
| | further navigation events are fired on it. If the |
| | developer is spinning the globe, the event |
| | handler for this event should stop spinning the |
| | globe. |
| | Cancelling this event will prevent the new |
| | window from being opened, and the navigation |
| | will not take place. |
| event LoadingImageCancelEventHandler | Raised when an image is about to be navigated |
| LoadingImage | to. |
| | Cancelling this event will prevent the image |
| | from being opened. |
| event ImageLoadingErrorEventHandler | Raised when an error is encountered while |
| ImageLoadingError | navigating to or loading an image. |
| event ImageLoadedCancelEventHandler | Raised when an image is fully loaded. |
| ImageLoaded | |

Event arguments of an exemplary embodiment of the INavigator class are described in Table 4.

TABLE 4

| EventArg | Properties |
|---|---|
| NavigatingCancelEventArgs | Uri - URI of the markup page to navigate to. |
| | Content - Root of the element tree being navigated to. |
| | (Note: Only one of the Content or Uri property |
| | will be set, depending on whether the |
| | navigation was to a Uri or an existing element tree.) |
| | NavigationMode - Enum {New, Back, |
| | Forward, Refresh} where New means a new |
| | navigation, Forward, Back, and Refresh mean |
| | the navigation was initiated from the |
| | GoForward, GoBack, or Refresh method (or |
| | corresponding UI button). |
| | NavigationData - Extra data specified by the |
| | developer to pass along with the navigation |
| | This may be used as an identifier for |
| | asynchronous navigations, so the developer can |
| | determine which navigation an event applies to. |
| | Cancel - The event handler can cancel the |
| | navigation by setting this to true. By default it's |
| | set to false, which allows the navigation to proceed. |
| NavigationErrorCanelEventArg | Uri - URI of the markup page to navigate to. |
| | Content - Root of the element tree being navigated to. |
| | (Note: Only one of the Content or Uri property |
| | will be set, depending on whether the |
| | navigation was to a Uri or an existing element tree.) |
| | WebExceptionStatus - Error code returned by |
| | the response header. |
| | Exception - Exception that was thrown. |
| | NavigationData - Extra data specified by the |
| | developer to pass along with the navigation |
| | This may be used as an identifier for |
| | asynchronous navigations, so the developer can |
| | determine which navigation an event applies to. |
| | Cancel - The event handler can prevent the |
| | default error message from being displayed to |
| | the user by setting this to false. A handler |
| | for this event might redirect to a custom error |
| | page or put up a custom error message. By |
| | default it's set to false, which allows the default |
| | error message to be displayed. |
| NavigationEventArgs | Uri - URI of the content navigated to. |
| | Content - Root of the element tree navigated to. |
| | (Note: Only one of the Content or Uri property |
| | will be set, depending on whether the |
| | navigation was to a Uri or an existing element tree.) |
| | NavigationInitiator - Indicates whether this |
| | NavigationContainer is initiating the navigation |
| | or whether a parent NaviagionContainer is |
| | being navigated (e.g., the current |
| | NavigationContainer is a frame inside a page |
| | that's being navigated to inside a parent |
| | NavigationContainer). A developer can use this |
| | property to determine whether to spin the globe |
| | on a LoadStarted event or to stop spinning the |
| | globe on a LoadCompleted event. If this |
| | property is False, the INavigator's parent |
| | INavigator is also navigating and the globe is |
| | already spinning. If this property is True, the |
| | navigation was initiated inside the current |
| | frame, and the developer should spin the globe |
| | (or stop spinning the globe, depending on |
| | which event is being handled.) |
| | NavigationData - Extra data specified by the |
| | developer to pass along with the navigation |
| | This may be used as an identifier for |
| | asynchronous navigations, so the developer can |
| | determine which navigation an event applies to. |

Synchronous Navigation

On the Web today, all navigation is asynchronous. Some applications, particularly when installed locally, may prefer synchronous navigation so all UI on a page appears simultaneously. It also may make sense for a particular frame to always navigate synchronously (e.g., if it only contains chrome) or asynchronously (e.g., if it only contains content). There are also times when a developer wants a particular navigation instance to by synchronous, for example, when navigating to a PageFunction. If the developer wants to pass some state to the new PageFunction that will be relected in the UI the PageFunction displays, he needs to be able to navigate to the UI and then set a property on it in the PageFunction's constructor. If the navigation is asynchronous, he can't do this because the element he wants to change may not have been parsed yet.

By default, all navigation (except Chrome Navigation) is asynchronous unless otherwise specified. However, a developer may specify that an application's default navigation behavior is synchronous by setting the value of the synchronous attribute in the Application definition to “true”.

<NavigationApplication ... Synchronous=“true”...>

A developer can also specify that the default navigation behavior for a particular INavigator (NavigationContainer or NavigationWindow) is synchronous by setting the Synchronous attribute on the NavigationContainer or NavigationWindow to “true”.

<NavigationWindow ... Synchronous=”true”>
<Frame ... Synchronous=”true”>

If the default navigation behavior for the application is synchronous, a developer can override that for a specific NavigationContainer or NavigationWindow by setting the Synchronous attribute on it to “false”.

To specify synchronous navigation on a hyperlink, a developer can set the value of the Synchronous attribute on the hyperlink to “true.”

<HyperLink ... Synchronous=”true”>

If the default navigation behavior for the application or the containing NavigationContainer is synchronous, a developer can override that for a specific hyperlink by setting the synchronous attribute to “false” on that hyperlink.

Although the invention has been described in language specific to computer structural features, methodological acts, and by computer readable media, it is to be understood that the invention defined in the appended claims is not necessarily limited to the specific structures, acts or media described. Therefore, the specific structural features, acts, and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. An application for execution on a computer system, the application creating a user interface comprising:
at least one first frame synchronously rendering a first resource into a display area defined by the first frame, the first resource being displayed to a user as part of the user interface;
at least one second frame asynchronously rendering a second resource into a display area defined by the second frame, the second resource being displayed to the user as part of the user interface; and
wherein the first frame and the second frame are instances of the same object class.

2. The application of claim 1, wherein at least one first frame and at least one second frame are displaying resources to the user simultaneously.

3. The application of claim 1, wherein the first resource is synchronously downloaded from a first remote location on a computer network prior to being synchronously rendered and the second resource is asynchronously downloaded from a second remote location on the computer network prior to being asynchronously rendered.

4. The application of claim 1, wherein the first resource is identified by an identifier provided by the application to the first frame.

5. The application of claim 4, wherein the identifier is a uniform resource identifier.

6. The application of claim 1, wherein the first and second resources include instructions regarding how they are to be rendered.

7. The application of claim 1, wherein the first resource is a control resource allowing a user to control the operation of the application.

8. A method of creating a user interface for an application to a user comprising:
instantiating a first navigation object, the first navigation object having a synchronicity attribute;
passing the first navigation object an identifier of a resource to render as part of the user interface for the application;
synchronously navigating, by the first navigation object, to the resource if the synchronicity attribute has a first value; and
asynchronously navigating, by the first navigation object, to the resource if the synchronicity attribute has a second value.

9. The method of claim 8, further comprising:
setting the synchronicity attribute to the first value or the second value based on a default synchronicity associated with the application.

10. The method of claim 8, further comprising:
setting the synchronicity attribute to the first value or the second value based on a synchronicity associated with the identifier.

11. The method of claim 8, further comprising:
receiving, by the first navigation object, a synchronicity parameter and the identifier in a call to a navigate method exposed by the first navigation object; and
navigating to the resource synchronously or asynchronous based on the synchronicity parameter regardless of a current value of the synchronicity attribute of the first navigation object.

12. The method of claim 8, wherein synchronously navigating comprises:
retrieving all of the data for the resource before parsing any of the data for the resource;
parsing the data for the resource before rendering any of the data for the resource; and
rendering the parsed data for the resource to create at least a portion of the user interface of the application.

13. The method of claim 8 wherein asynchronously navigating comprises:
retrieving data for the resource and passing the data to the parser as the data is retrieved;
parsing a first element of the data for the resource after retrieving the first element but before retrieving a second element of the data for the resource;
laying out the first element before parsing the second element; and
rendering the first element before laying out the second element.

14. The method of claim 9 further comprising:
instantiating a second navigation object, the second navigation object having the synchronicity attribute;
passing the second navigation object a second identifier of a second resource to render as part of the user interface for the application;
setting the synchronicity attribute of the second navigation object to a value different from the default synchronicity associated with the application;
synchronously navigating, by the second navigation object, to the second resource if the synchronicity attribute has the first value; and
asynchronously navigating, by the second navigation object, to the second resource if the synchronicity attribute has the second value.

15. The method of claim 14, wherein the first navigation object and the second navigation object are objects of the same class.

16. The method of claim 15, wherein the first navigation object and the second navigation object both expose the same navigation application programming interface.

17. A computer-readable medium storing a computer-interpretable data structure that identifies a resource, the data structure comprising:
a resource identifier identifying the name and location of data associated with a resource on a network, wherein the resource if navigated to by a navigation object is rendered to form at least part of a user interface displayed by an application to a user; and
a synchronicity designator associated with the resource identifier, the synchronicity designator causes the navigation object to navigate synchronously if the synchronicity designator is a first value and asynchronously if the synchronicity designator is a second value.

18. The computer-readable medium of claim 17, wherein the synchronicity designator overrides the current synchronicity setting of the navigation object.

19. The computer-readable medium of claim 17, wherein the synchronicity designator overrides the current synchronicity setting of the navigation object every time the navigation object is directed to navigate to the resource identified by the data structure.

20. A method of retrieving and rendering data with an application comprising:
specifying a desired synchronicity for a navigation frame using a synchronicity attribute of the navigation frame;
if the desired synchronicity for the navigation is synchronous, setting the synchronicity attribute to a first value that causes the navigation frame to navigate to a resource synchronously;
if the desired synchronicity for the navigation is asynchronous, setting the synchronicity attribute to a second value that causes the navigation frame to navigate to a resource asynchronously; and
navigating, by the navigation frame, to a resource in accordance with the synchronicity attribute.

21. The method of claim 20, wherein navigating to a resource asynchronously comprises downloading metadata of the resource, including any metadata remote from the resource but identified as part of the resource;
parsing the metadata into elements; and
rendering each element as soon as each element is parsed.

22. The method of claim 20, wherein navigating to a resource synchronously comprises
downloading the metadata of the resource, including any metadata remote from the resource but identified as part of the resource;
parsing the metadata into elements; and
rendering the elements in a single operation after all of the metadata of the resource has been parsed.

23. The method of claim 20, wherein specifying comprises:
selecting, by a developer during creation of the application, a default synchronicity for the application.

24. The method of claim 23, wherein specifying further comprises:
setting the synchronicity attribute to the default synchronicity for the application.

25. The method of claim 23, wherein specifying further comprises:
setting the synchronicity attribute to a value different from the default synchronicity for the application.

26. The method of claim 21, wherein downloading comprises:
downloading metadata of a resource from a designated location on network.

27. The method of claim 22, wherein downloading comprises:
downloading metadata of a resource from a designated location in a local machine tree.

28. A computer-readable medium encoding computer-executable instructions for a class of navigation objects, an instantiated navigation object of the class comprising:
a synchronicity attribute determining whether the instantiated navigation object navigates synchronously or asynchronously; and
an application programming interface that includes a function for setting the synchronicity attribute to a first value or a second value.

29. The computer-readable medium of claim 28, wherein the class of navigation objects is included in a class library of an operating system and the class is provided as a resource for use by applications running on the operation system.

30. The computer-readable medium of claim 28, wherein the application programming interface includes a first function for getting a current value of the synchronicity attribute of the instantiated navigation object.

31. The computer-readable medium of claim 28, wherein the application programming interface includes a second function that causes the instantiated navigation object to navigate to a resource, the second function if called with a synchronicity value overriding the synchronicity attribute thereby causing the navigation to be performed with the synchronicity associated with the synchronicity value.

32. A computer-readable medium encoding computer-executable instructions for executing on a computer a computer process for retrieving data from a network and rendering data on a display, said computer process comprising:
instantiating a first object of an navigation object class;
setting a synchronicity attribute of the first object to a first value;
synchronously navigating, by the first object, to a first resource on the network or the computer;
instantiating a second object of the navigation object class;
setting the synchronicity attribute of the second object to a second value; and
asynchronously navigating, by the second object, to a second resource on the network or the computer concurrently with the synchronously rendering by the first object.

33. The computer-readable medium of claim 31 further comprising:
changing the synchronicity attribute of the first object to the second value; and
in response to changing the synchronicity attribute of the first object, asynchronously navigating, by the first object, to a third resource.
